(19) United States
(12) Patent Application Publication
(10) Pub. No.: US 2013/0150222 A1
(43) Pub. Date: Jun. 13, 2013

(54) ROLLER CAP, CORRESPONDING ROLLER COVER AND ROLLER FRAME PROVIDED WITH SUCH ROLLER CAP, RESULTING TOOL, AND KIT FOR ASSEMBLING THE SAME

(71) Applicants: Roméo ARVINTE, Laval-des-Rapides (CA); François PANFILI, Berthierville (CA)

(72) Inventors: Roméo ARVINTE, Laval-des-Rapides (CA); François PANFILI, Berthierville (CA)

(73) Assignee: A. RICHARD TOOLS CO./OUTILS A. RICHARD CO., Berthierville (CA)

(21) Appl. No.: 13/465,676

(22) Filed: May 7, 2012

Related U.S. Application Data
(60) Provisional application No. 61/570,058, filed on Dec. 13, 2011.

(51) Int. Cl. F16C 13/00; B23P 19/00

(52) U.S. Cl. 492/47; 29/700

(57) ABSTRACT

A roller cap for removably mounting onto a distal end of an oversized roller cover adapts the oversized roller cover so that it can be used with a standard roller frame. The cap has a mounting portion mounted onto the distal end of the oversized roller cover and has a peripheral outer surface which frictionally engages with an inner bore of the oversized roller cover. A receiving portion is connected to the mounting portion and receives and frictionally secures the standard roller frame. The standard roller frame is passed through an aperture of the receiving portion, enabling the oversized roller cover to be used with the standard roller frame. A kit has at least one oversize roller cover, a standard roller frame and a cap. An inner tube can connect the receiving portions of caps, guiding the roller frame and producing a greater frictional fit.

### RELATED APPLICATION

The present invention relates to the general field of painting tools. More particularly, the present invention relates to a roller cap, to a corresponding roller cover and roller frame provided with such a roller cap, to a resulting tool, and to a kit for assembling the same. The present application claims benefit of U.S. provisional application No. 61/570,058 filed on Dec. 13, 2011 and which application is incorporated herein by reference. To the extent appropriate, a claim of priority is made to the above disclosed application.

### FIELD OF THE INVENTION

The present invention relates to the general field of painting tools. More particularly, the present invention relates to a roller cap, to a corresponding roller cover and roller frame provided with such a roller cap, to a resulting tool, and to a kit for assembling the same.

### BACKGROUND OF THE INVENTION

Known in the art are various roller frames and roller covers for applying paint to surfaces, for example. Typical roller covers are cylindrical, and have a fabric which circumferentially covers the exterior surface of the roller cover for being coated with paint. The fabric is often glued to a PVC cylindrical core. In a typical application, a roller cover is mounted on a roller frame, which typically receives a handle and/or an extension pole, thus forming a resulting paint roller. Paint is then applied to the roller cover by rotating the roller cover in the paint, and the paint roller is then used to transfer the paint from the roller cover to a surface.

One such paint roller is described in U.S. Pat. No. 7,120,963 B2 to KIM. The patent describes a paint roller mounting assembly which receives a shaft of a small-diameter paint roller handle having an outer cylinder. The roller cover is mounted to the outer cylinder and an end piece is inserted therein. The end piece has two chambers, which provide a stable fit to the roller cover mounted onto the cylinder.

Another paint roller is described in U.S. patent application published under publication number US 2010/0218719 A1 and naming BELLEY as the inventor. The application relates to a roller painting kit which has a roller cage adapter mounted onto a roller section of a paint frame. A roller cover is inserted over the roller cage adapter. The roller cover is flexible so that it can be rolled onto itself for storage.

Other U.S. patents and patent applications known to the Applicant and relating to painting tools and cylinders include the following: U.S. Pat. Nos. 2,699,903; 5,269,039; 5,784,798; 7,028,365 B2; 7,120,963; 2006/0196990 A1; 2010/0218719 A1; and 2011/0101152 A1.

The following Japanese patent document is also known to the Applicant: JP 2002301421.

Also known in the art are roller covers with a greater outer diameter and a resulting greater circumferential area than conventional roller covers. These larger-diameter roller covers are also known as “oversized”, “super-sized” or “jumbo” roller covers, and they have the following advantages, for example: a) they can hold a greater volume of paint and thus reduce the number of times a painter must re-coat the roller cover, which greatly improves efficiency; b) they can paint more surface area in a given period of time, reducing manpower costs; c) they are easy to grip and thus clean so as to be re-used, which reduces supply costs; etc.

However, despite the substantial advantages of these large-diameter roller covers, there is often lacking an efficient and inexpensive means to employ them. The principal reason for this shortcoming is that large-diameter roller covers require larger or custom-made roller frames to accommodate them. Known in the art are the substantial disadvantages associated with such larger roller frames, for example: a) they are not readily available in many different markets because a standard 1½″ inside diameter roller cover is the roller cover that is most often sold in hardware stores and the like; b) they are costlier to produce and harder to procure when compared to standard roller frames, thus increasing the cost of supplies; c) larger roller frames have more exposed surfaces in which paint can infiltrate and dry, making them harder to clean and increasing unit-labour hours; d) larger roller frames are frequently heavier than standard frames, which can fatigue the painter when used for a significant period of time; etc.

Hence, in light of the aforementioned, there is a need for a device which, by virtue of its design and components, can allow for the inexpensive and efficient use of large-diameter roller covers, and that would be able to overcome or at least minimize some of the aforementioned prior art problems.

### SUMMARY OF THE INVENTION

An object of the present invention is to provide a roller cap (or simply “cap”) which, by virtue of its design and components, satisfies some of the above-mentioned needs and is thus an improvement over other related devices and/or methods known in the art.

More particularly, an object of the present invention is to provide a removable, reusable roller cap which adapts to an oversized roller cover, so as to enable the oversized roller cover to be secured to, and used with, a standard roller frame. Such a roller cap can be inserted at one or both ends of the oversized roller cover, and the standard roller frame can then be inserted through either one of, or both, of the inserted roller caps, thereby adapting the oversized roller to be used with the standard roller frame. A further object of the present invention is to provide kit for creating a paint tool whose components, including an oversized roller cover, a standard roller frame, and a roller cap, are easily assembled and reusable.

In accordance with an aspect of the present invention, there is provided a cap for removably mounting onto a distal end of an oversized roller cover so as to enable the oversized roller cover to be used with a standard roller frame, the cap comprising:
a mounting portion removably mountable onto the distal end of the oversized roller cover, the mounting portion having a peripheral outer surface configured for frictional engagement with an inner bore of the oversized roller cover; and
a receiving portion operatively connectable to the mounting portion for removably receiving the standard roller frame, the receiving portion having a slot configured for frictionally receiving the standard roller frame, thereby enabling the oversized roller cover to be used with the standard roller frame.

Such a cap advantageously allows for an oversized or “jumbo” paint roller cover to be used with a standard roller frame, which can be procured in many hardware or similar stores. The cap may be provided with a fixture, such as a lip, which prevents its ingress into the inner bore of the roller cover, thereby further securing the cap in position and facilitating its use. Vanes or other support structures can connect the mounting portion with the receiving portion so as to provide reinforcement to the cap when frictionally engaged with the roller cover and the roller frame.

Other techniques, such as friction enhancers, can be mounted on the peripheral outer surface so as to further enhance the frictional engagement of the outer surface with the inner bore. These friction enhancers can be ribs, grips, nubs, stubs, etc. It is thus appreciated that the cap can provide a frictional fit between both the roller cover and the cap, and the roller frame and the cap, which allows the roller cover and roller frame to rotate as if they were one element.

In one embodiment, the mounting portion can have an inner peripheral surface which varies in shape or diameter along the length of the mounting portion. This advantageously allows the cap to have an improved aesthetic, which broadens the appeal of the cap to both end-customers and distributors.

In another embodiment, an inner tube can be connected to either one roller cap, or both roller caps. This inner tube advantageously can serve as a guide or conduit for the standard roller frame when it is inserted through either one or both roller caps, further enhancing the frictional fit of the standard roller frame with the receiving portion.

In accordance with another aspect of the invention, there is provided a kit for creating a painting tool, the kit comprising:
an oversized roller cover;
a standard roller frame; and
a cap comprising:
   a mounting portion having a peripheral outer surface configured for frictional engagement; and
   a receiving portion operatively connectable to the mounting portion, the receiving portion having a slot.

In accordance with another aspect of the invention, there is provided a cap for adapting onto a roller frame having a rotatable cage with an outer configuration intended to be used with a first type of roller cover having a given inner bore, so as to enable said roller frame via the cap to be used with a second type of roller cover having a larger inner bore, the cap comprising:
a mounting portion having an aperture configured for removably mounting about a portion of the cage of the roller frame; and
a receiving portion projecting radially outwardly from the mounting portion, and having an outer peripheral receiving surface complementary to the inner bore of the second type of roller cover for allowing the roller frame to receive said type of roller cover.

According to a particular embodiment, and as will be explained in greater detail hereinbelow, the present cap enables a “standard” roller frame intended to be used with a “standard” roller cover (i.e. first type of roller cover) to be further used with an “oversized” or “jumbo” paint roller (i.e. second type of roller cover). As will also be explained in greater detail hereinbelow, the cage of the roller frame need not be limited to a “circular” one, but in such a case, the aperture of the mounting portion could be complementary to the diameter of the cage. It is worth mentioning also that the mounting portion of the cap or “adaptor” need not be limited to being positioned at a distal end of the roller cover, and could be conveniently placed along the roller frame for bridging the gap between the “standard” paint roller frame and the “jumbo” paint roller cover.

According to yet another aspect of the present invention, there is also provided a method of manufacturing and/or installing the above-mentioned roller cap.

According to yet another aspect of the present invention, there is provided a larger-diameter roller cover provided with at least one of the above-mentioned roller caps.

According to yet another aspect of the present invention, there is provided a roller frame provided with the above-mentioned larger-diameter roller cover.

According to yet another aspect of the present invention, there is provided a handle and/or pole provided with the above-mentioned roller frame so as to form a resulting tool.

According to yet another aspect of the present invention, there is also provided a set of components for interchanging with components of the above-mentioned kit.

According to yet another aspect of the present invention, there is also provided a method of assembling components of the above-mentioned kit and/or set.

The objects, advantages and other features of the present invention will become more apparent upon reading of the following non-restrictive description of preferred embodiments thereof, given for the purpose of exemplification only, with reference to the accompanying drawings.

### BRIEF DESCRIPTION OF THE DRAWINGS

FIG. 1 is a perspective view of a roller cap mounted to an oversized roller cover and standard roller frame, according to a preferred embodiment of the present invention.

FIG. 2 is an exploded view of two roller caps and an oversized paint roller, according to a preferred embodiment of the present invention.

FIG. 3 is an end view of what is shown in FIG. 1.

FIG. 3A is a side elevational cross-sectional view of what is shown in FIG. 3 taken along the line 3A-3A.

FIG. 4 is a perspective view of the roller cap of FIG. 1.

FIG. 5 is a rear perspective view of what is shown in FIG. 4.

FIG. 5A is a rear perspective view of a roller cap having a slit, according to a preferred embodiment of the present invention.

FIG. 6 is a side elevational view of what is shown in FIG. 4.

FIG. 7 is a perspective cross-sectional view of the roller cap of FIG. 6 taken along the line 7-7.

FIG. 8 is a perspective view of a roller cap, according to another preferred embodiment of the present invention.

FIG. 9 is a rear perspective view of what is shown in FIG. 8.

FIG. 10 is a side elevational view of what is shown in FIG. 8.

FIG. 11 is a perspective cross-sectional view of the roller cap of FIG. 10 taken along the line 11-11.

FIG. 12 is a perspective view of two roller caps connected by a tube extension and mounted into an oversized roller cover, according to a preferred embodiment of the present invention.

FIG. 13 is a perspective view of the two roller caps connected with a tube extension, as inserted into the assembly of FIG. 12.

FIG. 14 is a side elevational view of what is shown in FIG. 12.

FIG. 14A is a side elevational cross-sectional view of what is shown in FIG. 12 taken along the line 14A-14A.

FIG. 15 provides end views of an oversized roller cover and a standard-sized roller cover, according to a preferred embodiment of the present invention.

### DETAILED DESCRIPTION OF PREFERRED EMBODIMENTS OF THE INVENTION

In the following description, the same numerical references refer to similar elements. The embodiments, geometrical configurations, materials mentioned and/or dimensions shown in the figures are preferred, for exemplification purposes only.

Moreover, although the present invention was primarily designed for being applied to larger-diameter roller covers used for painting purposes, for example, it may be used to adapt other types of tubes, cylinders, annuli and/or other devices, or be used for other purposes, as apparent to a person skilled in the art. For this reason, expressions such as “paint roller cover”, “larger-diameter roller cover”, “paint roller frame”, etc., as used herein should not be taken as to limit the scope of the present invention to painting applications, and includes all other kinds of materials, objects and/or purposes with which the present invention could be used and may be useful. Indeed, it may be appreciated that the present invention could be used to reduce/enlarge an effective diameter of a roll of material so that it can be used with a particular tool, for example.

Moreover, in the context of the present invention, the expressions “roller cover”, “larger-diameter roller cover”, “super-sized roller cover”, “oversized roller cover”, “jumbo roller cover” and any other equivalent expressions known in the art will be used interchangeably. This applies for any other mutually equivalent or related expressions, such as “painting”, “coating”, “coloring”, “covering” and “applying” as also apparent to a person skilled in the art.

Furthermore, in the context of the present description, it will be considered that expressions such as “connected” and “connectable”, or “mounted” and “mountable”, may be interchangeable, in that the present invention also relates to a kit with corresponding components for assembling a resulting paint tool.

In addition, although the preferred embodiment of the present invention as illustrated in the accompanying drawings comprises various components and although the preferred embodiment of the roller cap as shown consists of certain geometrical configurations as explained and illustrated herein, not all of these components and geometries are essential to the invention and thus should not be taken in their restrictive sense, i.e. should not be taken as to limit the scope of the present invention. It is to be understood, as also apparent to a person skilled in the art, that other suitable components and cooperations thereinbetween, as well as other suitable geometrical configurations may be used for the roller cap, any resulting tool, and corresponding parts, according to the present invention, as briefly explained and as can be easily inferred herefrom by a person skilled in the art, without departing from the scope of the invention.

### LIST OF NUMERICAL REFERENCES FOR SOME OF THE CORRESPONDING PREFERRED COMPONENTS ILLUSTRATED IN THE ACCOMPANYING DRAWINGS

10. roller cap (or simply “cap”)
20. mounting portion
21. outer surface diameter
22. peripheral outer surface (or “outer surface”)
24. fixture
24a. extension
26. friction enhancer
28. planar surface of mounting portion
29. peripheral inner surface (or “inner surface”)
29a. inner surface diameter
30. receiving portion
32. aperture of receiving portion
34. passage
36. aperture diameter
38. slit or cut
40. distal end of roller cover
50. support
60. inner tube
62. first extremity of inner tube
64. second extremity of inner tube
70. roller cover
72. inner bore of roller cover
80. roller frame

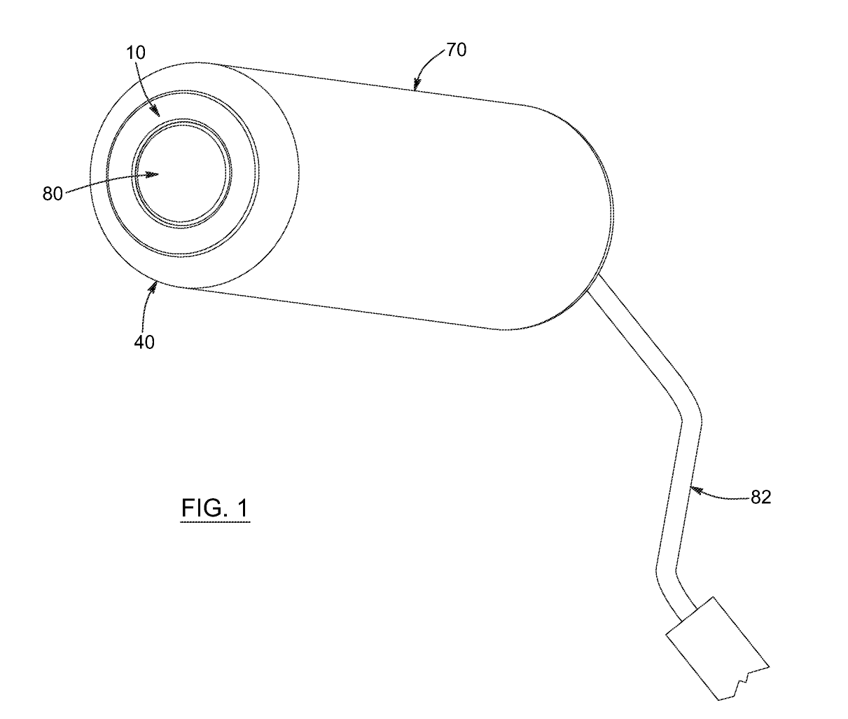

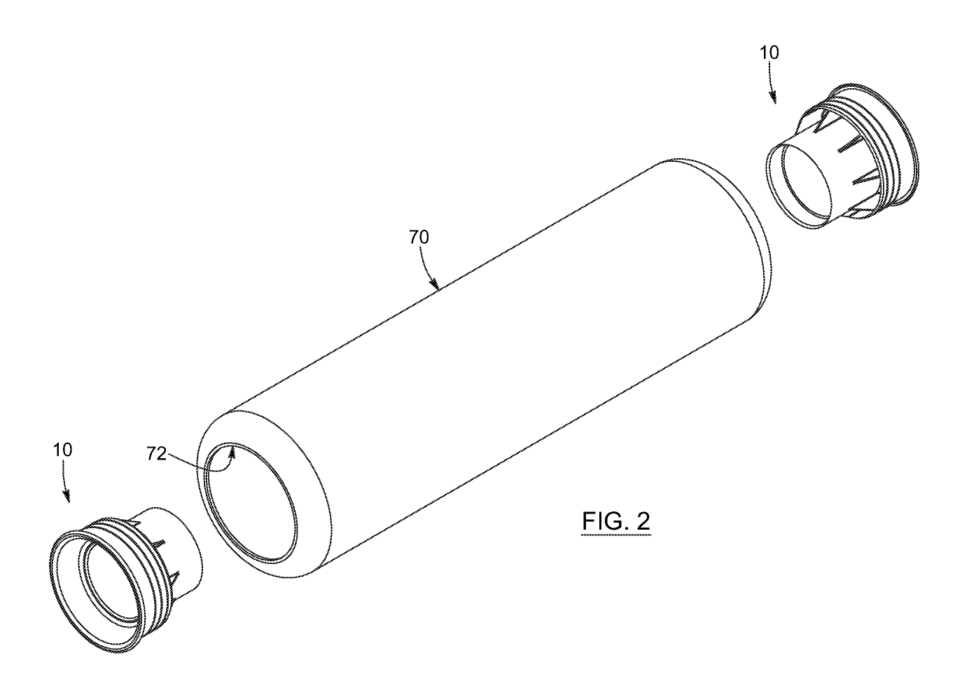

Broadly described, and as shown in FIGS. 1 to 3A, the roller cap (10) is a device which, in its preferred intended use, adapts to an oversized or larger-diameter roller cover (70) so as to allow the roller cover (70) to fit onto a standard roller frame (80) and be secured thereto. By “oversized” roller cover, it is understood that the roller cover used with the cap (10) is not limited to standard roller covers which are most commonly available and which usually have inner diameters of about 1½″, and that the cap (10) can be used with roller covers (70) having larger (or smaller) inner diameters than the diameter of conventional roller covers. The roller cover (70) has an inner bore (72) into which the cap (10) is inserted. Moreover, the term “cap” is not limiting, and is understood to include any plug, adapter, etc. which can be inserted and removed from a distal end (40) of a roller cover (70) or similar cylinder. Furthermore, a “standard roller frame” can be understood to mean any roller frame (80) commonly available in hardware stores and the like, which is normally intended to be used with a conventional roller cover, such as one with an inner diameter of 1½″. Also, the cage of the roller frame (80) need not be “cylindrical” or “circular” to be used with the present cap (10), as apparent to a person skilled in the art.

According to an embodiment, the roller cap (10) is removably inserted into at least one distal end (40) of the roller cover (70) and, as explained in more detail below, reduces the effective diameter of the roller cover (70) so that a roller frame (80) of a standard diameter may be inserted into the roller cover (70) equipped with the roller cap (10) and the roller cover (70) may be secured thereto. More particularly, it can be said that the cap (10) “bridges the gap” between the diameters or dimensions of both the roller cover (70) and the roller frame (80). Alternatively, the diameters or dimensions of both the roller cover (70) and the roller frame (80) can be bridged by mounting the cap (10) onto the roller frame (80), and then mounting the roller cover (70) thereon.

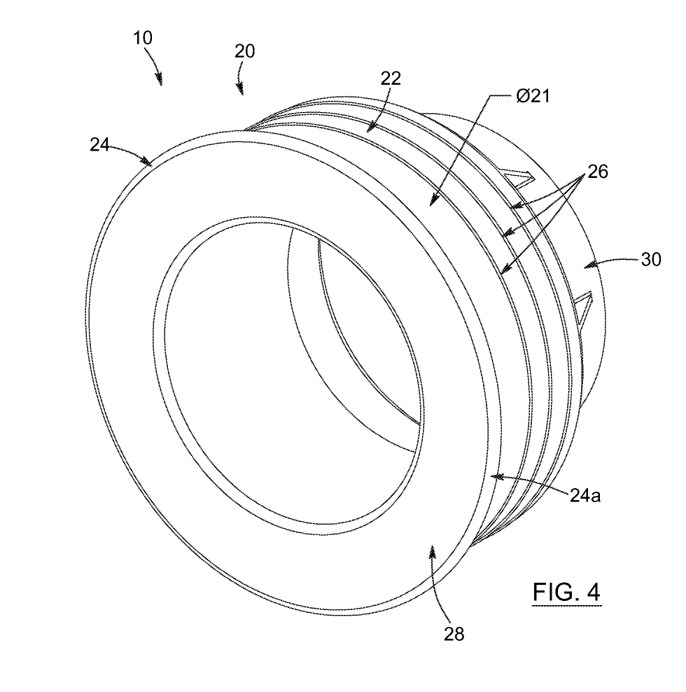

Turning now to FIG. 4, the cap (10) has a mounting portion (20) and a receiving portion (30).

The mounting portion (20) of the cap (10) can be removably mountable onto the distal end of the oversized roller cover. By “removably mountable”, it is understood that the mounting portion (20) can be both inserted into, and taken out of, the distal end of the roller cover. Alternatively, the mounting portion (20) and/or cap (10) can be fixedly attached to the roller cover, via appropriate fastening or securing means (i.e. screws, glue, etc.). In yet another alternative embodiment, the mounting portion (20) need not be mounted to the distal end of the roller cover, but can instead be mounted or frictionally engaged with the inner bore of the roller cover. The mounting portion (20) is preferably cylindrical, but is not limited to this shape. Indeed, the mounting portion (20) can be rectangular, pyramidal, or any other polygonal shape, provided that it can enter into frictional engagement with the inner bore. The mounting portion (20) has a peripheral outer surface (22). The peripheral outer surface (22) enters into contact with the inner bore of the roller cover, and can consist of any circular or segmented plane (i.e. curved, straight, etc.) which defines a perimeter of the mounting portion (20). The outer surface (22) can be made of any elastically deformable materials (i.e. thermoplastic, rubber, etc.) such that it can compress and expand in response to forces generated when the mounting portion (20) is inserted into, and removed from, the distal end of the roller cover.

The outer surface (22) frictionally engages the inner bore of the roller cover. The outer surface (22) can therefore be cylindrical, and in such a configuration would define an outer surface diameter (21), which may be about 2 inches. This frictional engagement may allow the mounting portion (20) to remain in a fixed position relative to the inner bore (i.e. so as to not to slide into or out of inner bore), and may include a press-fit. The frictional engagement can also allow the mounting portion (20) to engage in a non-slip rotational contact with the inner bore, which can allow the mounting portion (20), and ultimately the cap (10), to rotate without slip when the roller cover (10) rotates, such as when paint is being applied to a surface, for example.

This frictional enhancement can be improved by other exemplary features of the invention, which are now described. One such feature may include a fixture (24) which may engage with the roller cover so as to prevent inward ingress of the mounting portion (20) into the roller cover. The fixture (24) can be any protrusion, abutment or textured portion which abuts against the inner bore, distal end, and/or other part of the roller cover so as to reduce or prevent inward movement of the mounting portion (20). Indeed, the fixture (24) does not need to be positioned inside the roller cover, but can protrude from the cap (10) and affix to the roller frame, for example. One example of a fixture (24) includes an extension (24a) disposed along some of, or all, of the outer surface (22), near the part of the mounting portion (20) nearest in contact with the distal end of the roller cover. Such an extension (24a) can be continuous, meaning it can be an uninterrupted contour of the mounting portion (20) nearest the distal end of the roller cover. In such a configuration, the extension (24a) can exceed an edge of the distal end of the roller cover, and abut against said edge, thereby preventing inward ingress of the mounting portion (20). Such an extension can be any protrusion such as a brim, a rim, a lip, a skirt, etc. Alternatively, the extension (24a) can be discontinuous, and can consist of a plurality of spaced-apart and discrete elements extending from the outer surface (22) at certain radial positions (i.e. 90°, 180°, 270°, 360°) near the distal end of the roller cover.

As shown in FIG. 4, the fixture (24) may extend inward (i.e. towards the center of the mounting portion (20), for example) so as to create a planar surface (28) upon which text, logos, designs and/or trademarks may be applied.

Another exemplary feature for improving the frictional enhancement of the outer surface (22) with the inner bore of the roller cover can include a friction enhancer (26). Such a friction enhancer (26) can include multiple bumps or textured portions disposed along a part or the entire outer surface (22) so as to enhance frictional contact. One example of such friction enhancers (26) can be bands or strips running the length of the circumference of the outer surface (22) which interact with the inner bore of the roller cover and prevent or reduce lateral movement between the roller cover and the mounting portion (20). Alternatively, the friction enhancers (26) can be a series of discrete bumps or protrusions, arranged strategically on the outer surface (22) so as to maximize frictional contact. The friction enhancers (26) can consist of ribs, grips, nubs, strips, bands, etc. These friction enhancers (26) may reinforce the role of the fixture (24) in preventing inward ingress of the cap (10), and advantageously improve the frictional engagement by reducing or preventing outward movement of the cap (10) relative to the roller cover. Thus it is appreciated that, in combined use, the fixture (24) may prevent or limit inward movement of the cap (10) relative to the roller cover, and the force of friction created by the friction enhancers (26) prevents or limits both inward and outward movement.

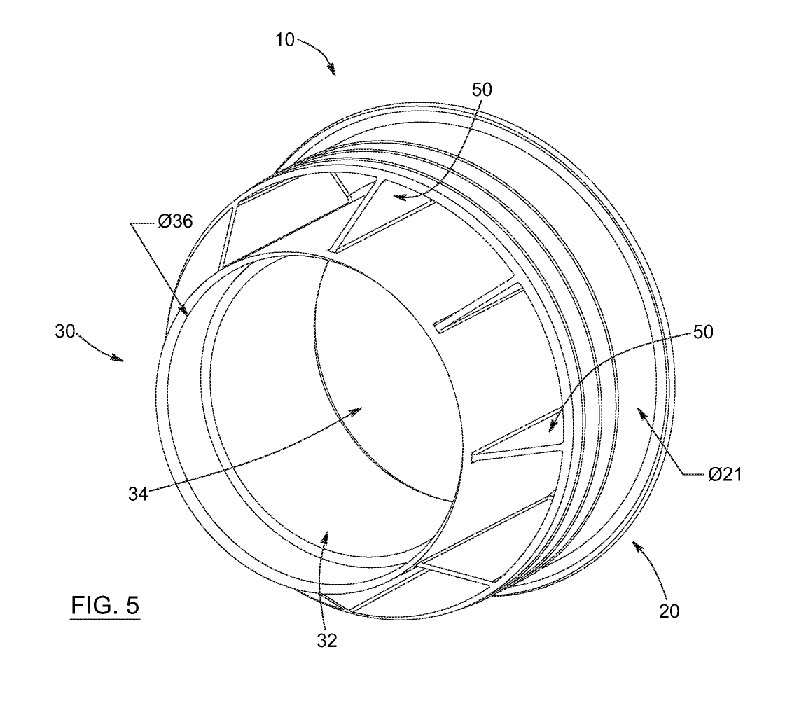

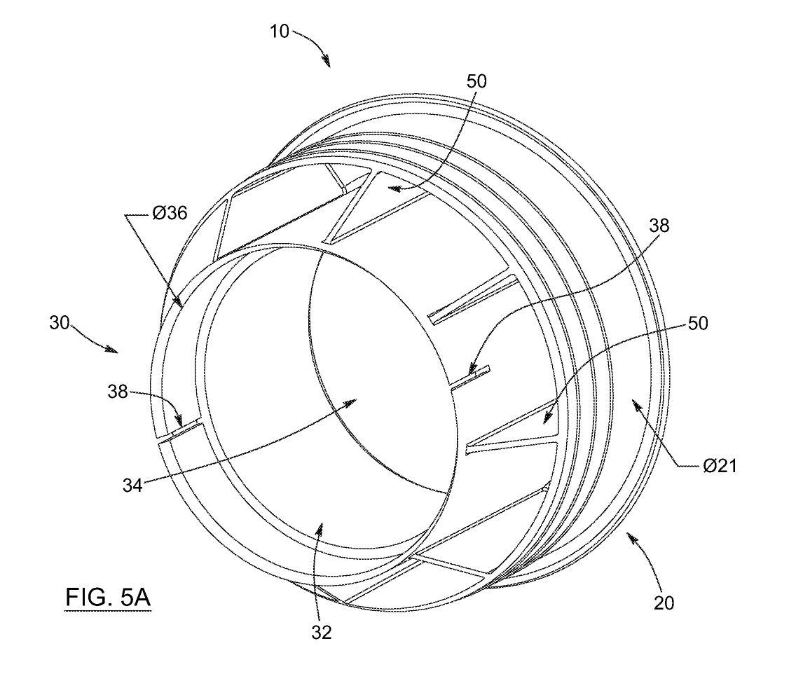

Turning now to FIG. 5, the cap (10) also has a receiving portion (30). The receiving portion (30) receives the standard roller frame and engages with it, thereby allowing the cap (10) to rotate free of slip with the roller frame. The receiving portion (30) is operatively connectable to the mounting portion (20). By “operatively connectable”, the receiving portion (30) is understood to connect to the mounting portion (20) such that both portions (20,30) cooperate so as to reduce the effective diameter of the roller cover/roller frame. In one example of such a configuration, both portions (20,30) can be integral or one-piece. Alternatively, the receiving portion (30) can be separate from the mounting portion (20), and subsequently mounted thereon. In yet another exemplary configuration, the receiving portion (30) can consist of a single aperture for frictionally receiving the roller frame. Numerous other configurations are possible and within the scope of the invention. As explained with the mounting portion (20) above, the standard frame is removably connected to the receiving portion (30), meaning that the roller frame can be connected to, and easily removed from, the receiving portion (30). Alternatively, the roller frame can be fixedly connected to the receiving portion (30) via suitable fastening or securing means (i.e. screws, glue, etc.).

The receiving portion (30) includes an aperture (32) wherein the roller frame is inserted. The aperture (32) can be any slot, hole, passage, etc. configured for receiving the roller frame, and frictionally engaging it. Although shown in FIG. 5 as “open”, the aperture (32) can be “closed”, or partially opened, depending on the roller frame being used and other relevant criteria. When in its open configuration, the aperture (32) can define a passage (34) which passes through both the mounting portion (20) and the receiving portion (30), thus allowing the roller frame to pass through both the receiving portion (30) and then the mounting portion (20). Alternatively, and when the aperture (32) is slightly or fully closed thereby creating a type of slot, the roller frame may pass through only the receiving portion (30) and frictionally nest therein. In yet another configuration, the aperture (32) can define a partially open passage (34) capable of frictionally receiving only a portion of the roller frame. In yet another alternative configuration, the aperture (32) and/or receiving portion (30) may include a slit or cut (38), either extending along the entirety of the receiving portion (30) or a portion thereof, thereby permitting the aperture (32) and/or receiving portion (30) to resiliently adapt to the insertion of the roller frame such that the aperture (32) and/or receiving portion (30) expands along the slit (38) when the roller frame is inserted, and contracts to a resting position when the roller frame is removed, as better shown in FIG. 5A.

The aperture (32) can be cylindrical. In such an exemplary configuration, the aperture (32) defines an aperture diameter (36), which can be measured along a line spanning the inside surfaces of the aperture (32). The aperture diameter (36) may be smaller (i.e. of a lower value) than the outer surface diameter (21). Indeed, the aperture diameter (36) can be substantially equal to, or be complementary to, the diameter of the roller frame, thereby ensuring an enhanced frictional fit. In such an exemplary configuration where the outer surface diameter (21) corresponds roughly to the inner diameter of the roller cover (i.e. of the inner bore) and where the aperture diameter (36) corresponds to the diameter of the roller frame, it is thus appreciated that the aperture (32) will frictionally engage the roller frame and the outer surface will frictionally engage the roller cover. Thus, a friction fit can be established between the cap (10) and the roller cover, and the cap (10) and the roller frame. Therefore, movement of the roller cover relative to the cap (10), and movement of the cap (10) relative to the roller frame, can both be minimised ensuring that the roller cover can be rotated with minimal slip, if any at all.

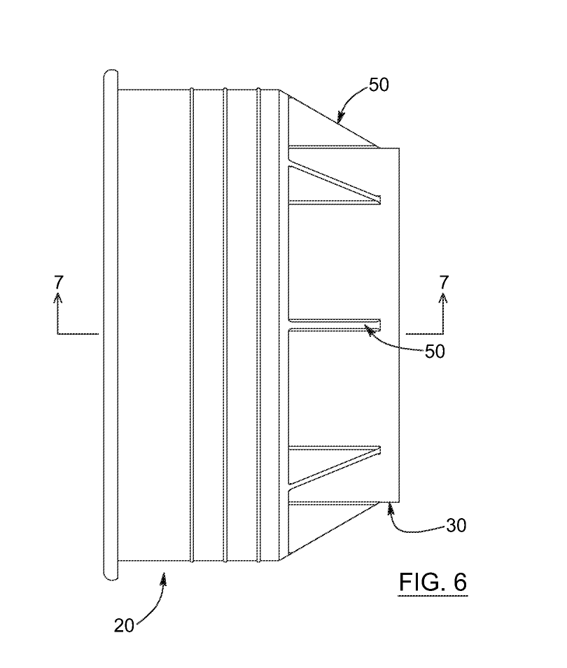

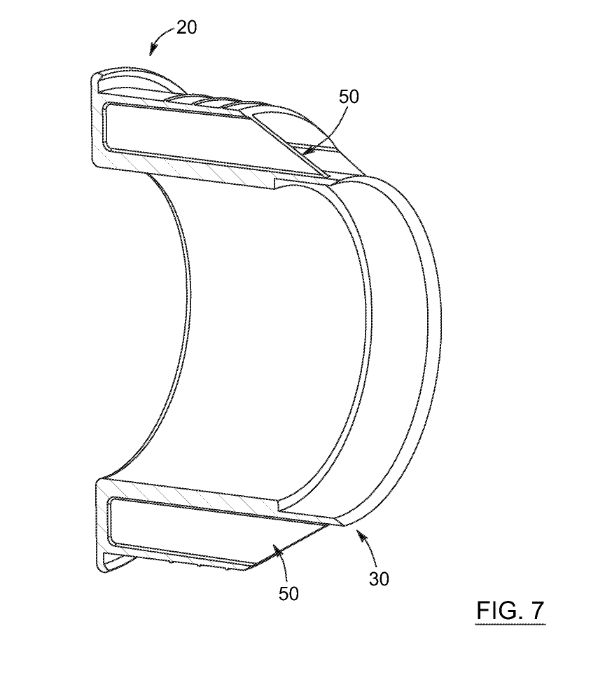

As mentioned previously, and in reference to FIGS. 5 to 7, the mounting portion (20) and the receiving portion (30) can be integral and/or one-piece units. These integral portions (20,30) can be connected by at least one support (50) which reinforces the cap (10) and provides structural rigidity thereto. The at least one support (50), or multiple supports (50), can thus link the mounting portion (20) to the receiving portion (30) and buttress such a link when the mounting portion (20) is compressed by the roller cover by dissipating such compressive forces at discrete points along the periphery of the receiving portion (30), and ultimately, the roller frame. Furthermore, the supports (50) can prevent the receiving portion (30) from being pushed into the mounting portion (20) when the roller frame presses against the receiving portion (30). Many different configurations of supports (50) are possible and within the scope of the present invention. One such example may include four supports (50) extending radially from the receiving portion (30) to the mounting portion (20) at 90 degree spaced-apart intervals. Alternatively, the support (50) can consist of one cylindrical block extending along the circumference of the receiving portion (30) between the mounting portion (20). Therefore, the supports (50) can be any one of vanes, struts, bars, rods and/or other similar elements.

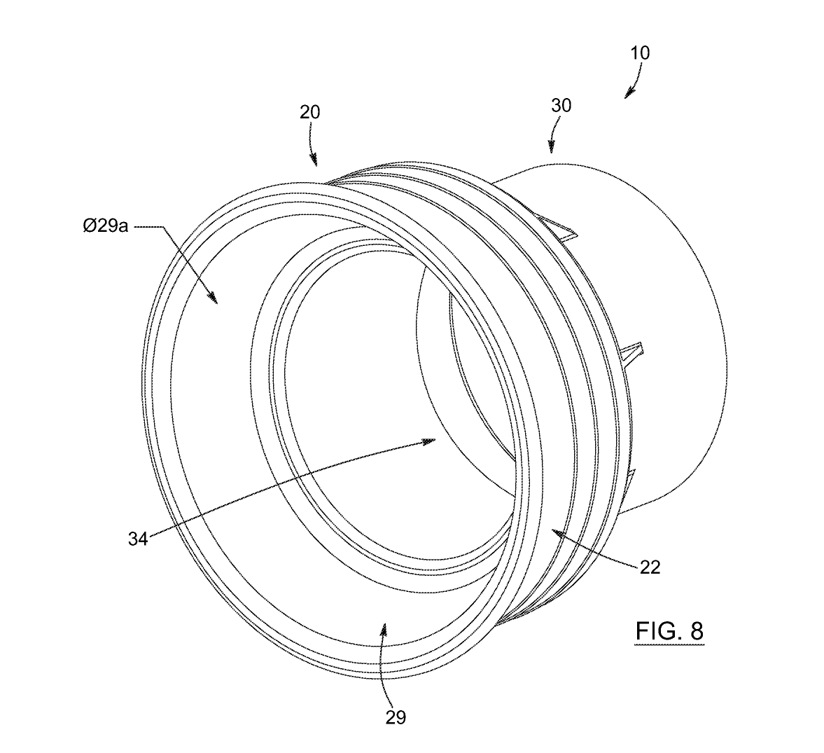

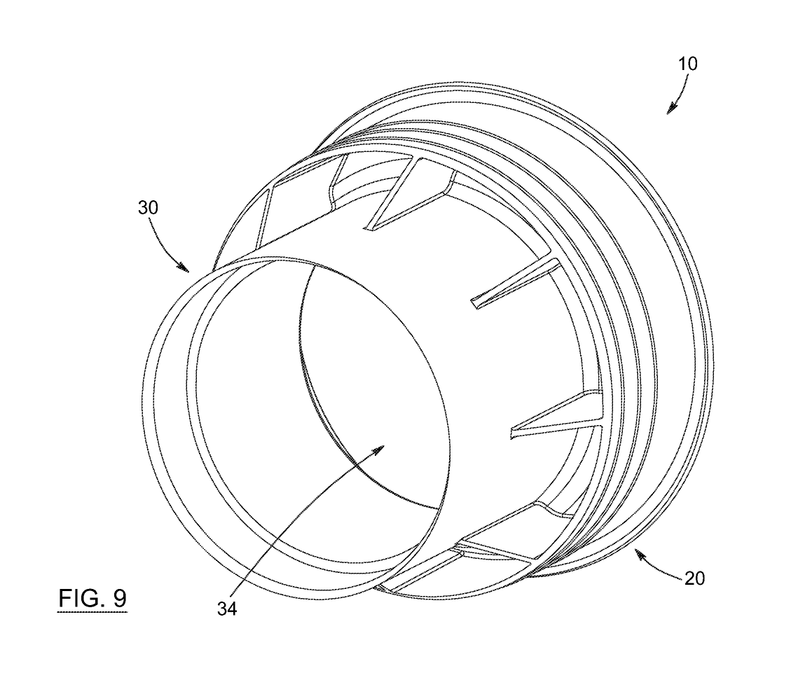

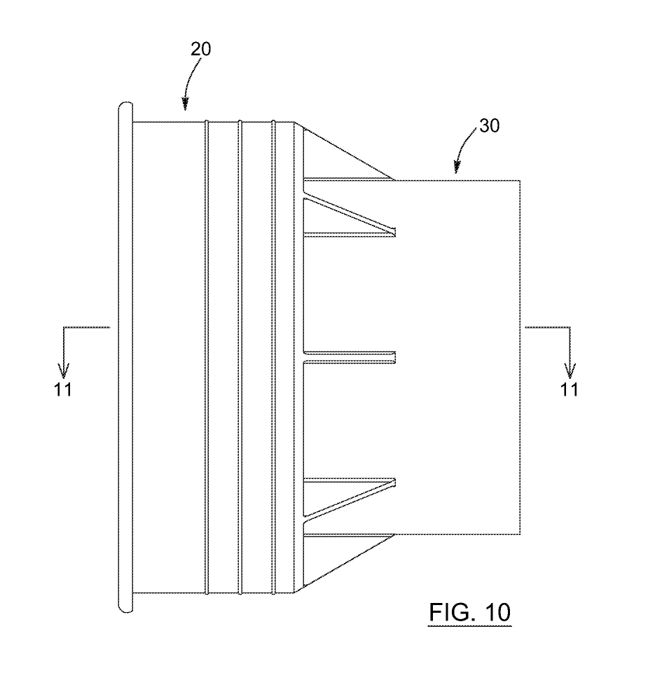

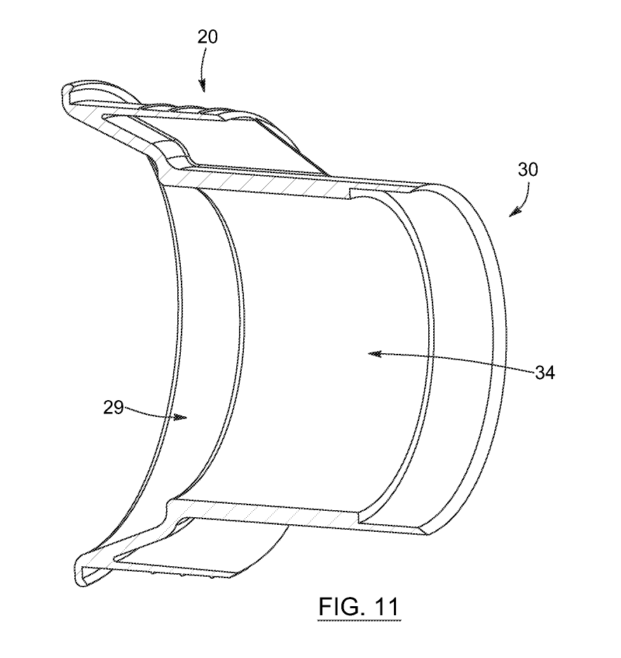

Referring to FIGS. 8 to 11, the mounting portion (20) can have a peripheral inner surface (29). The inner surface (29) can be opposed to, or simply another face of, the outer surface (22). The inner surface (29) may contour the interior of the mounting portion (20) adjacent to the passage (34) defined by the aperture of the receiving portion (30). The inner surface (29) offers an aesthetically pleasing appearance, as well as a surface to which logos, texts, images, designs and/or trade-marks can be affixed. The inner surface (29) can be substantially frustoconical along its length, meaning from the one end of the mounting portion (20) nearest the distal end of the roller cover, to another end of the mounting portion (20) further inside the roller cover near the receiving portion (30). In another configuration, the inner surface (29) defines an inner surface diameter (29a) which can vary (i.e. increase or decrease) along the same length of the mounting portion (20). In such a configuration, the inner surface diameter (29a) can decrease from the part of the mounting portion (20) nearest the distal end to the part nearest the receiving portion (30). The shape of the inner surface (29) is thus pleasing to the eye, and can have the additional advantage of not interfering with the edges of the roller cover and/or surface when the roller cover applies paint to the surface.

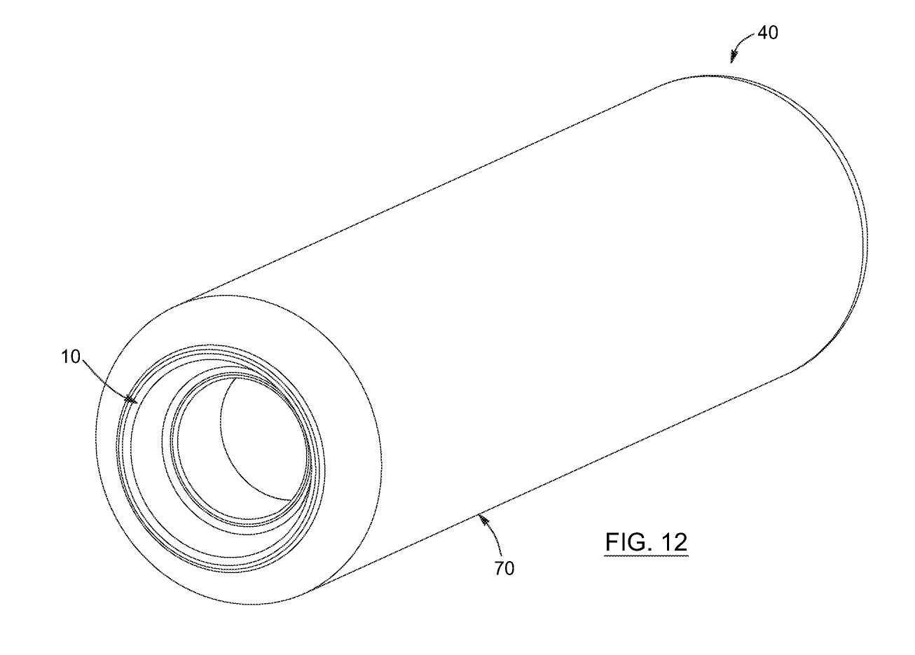

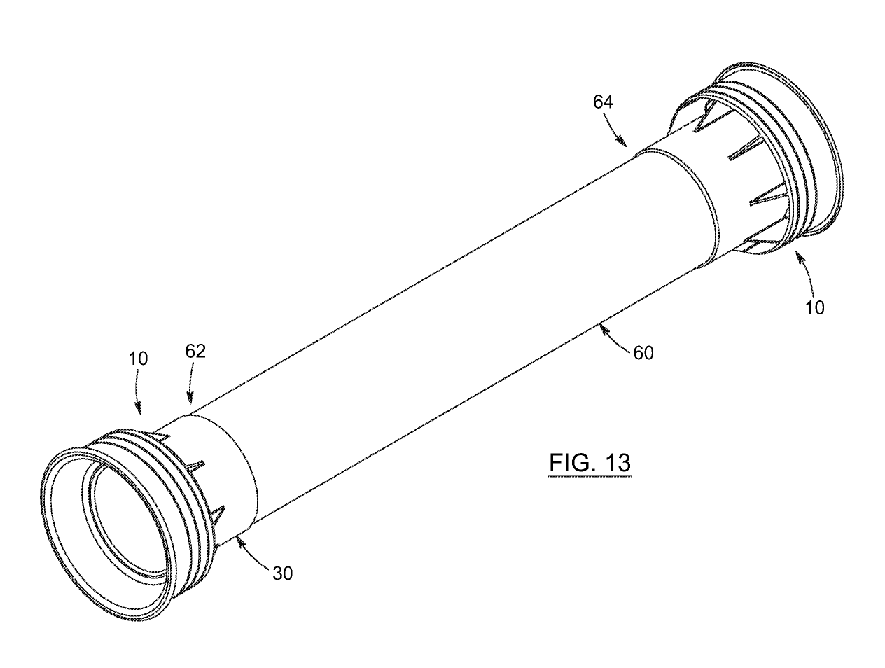

Turning now to FIGS. 12 to 14A, the cap (10) can be used with an inner tube (60). The inner tube (60) can be any plastic or PVC cylinder which connects to at least one cap (10) at its receiving portion (30). In so doing, the inner tube (60) can provide a guide path or passage for the roller frame inserted into the cap (10) and through the cap (10). Further advantageously, the inner tube (60) can provide an additional frictional fit area for engaging the roller frame. The inner tube (60) can have a first extremity (62) and an opposed second extremity (64). In one exemplary configuration where the inner tube (60) is joined to only one cap (10) of a roller cover (70), either extremity (62,64) can be mounted within the aperture of the receiving portion (30) of the cap (10). This mounting provides a secure and stable frictional fit, allowing only one cap (10) to be used to bridge the gap between the roller cover (70) and the roller frame. Alternatively, in the exemplary configuration where two caps (10) are inserted into both distal ends (40) of the roller cover (70), the inner tube (60) can be mounted at its first extremity (62) to one aperture of one cap (10), and at its second extremity (64) to the aperture of the other cap (10).

According to an aspect of the present invention, there is provided a kit for creating a painting tool. The painting tool can be connected to a pole or other like device so as to facilitate handling by a user, and so as to optimize painting applications, particularly at a distance from the user. The kit includes an oversized roller cover (70), a standard roller frame (80) for fitting on the oversized roller cover (70), and a cap (10) according to the present invention. Alternatively, the cap (10) can include a mounting portion (20) having a peripheral outer surface (22) configured for frictional engagement with the roller cover (70), and a receiving portion (30) operatively connectable to the mounting portion (20), the receiving portion having an aperture (32). The kit can also be used with an inner tube (60), such as the one described above, which can inserted into the receiving portion of at least one cap (10).

Having discussed some of the principal components and features of the cap (10) according to the present invention, some of the other preferential embodiments will be further discussed hereinbelow.

Indeed, as previously explained, the roller cap (10) is removably applicable to a distal end (40) of a roller cover (70) so as to adapt the roller cover (70) to receive a roller frame (80). It is to be understood that the roller cap (10) does not need to be removed or reusable, and can also be fixedly attached to the roller cover (70), as apparent to a person skilled in the art and as also previously explained. The cap (10) reduces the effective diameter of the roller cover (70), allowing the smaller-diameter distal end of the roller frame (80) to frictionally engage the cap (10), thus securing the roller cover (70) to the roller frame (80).

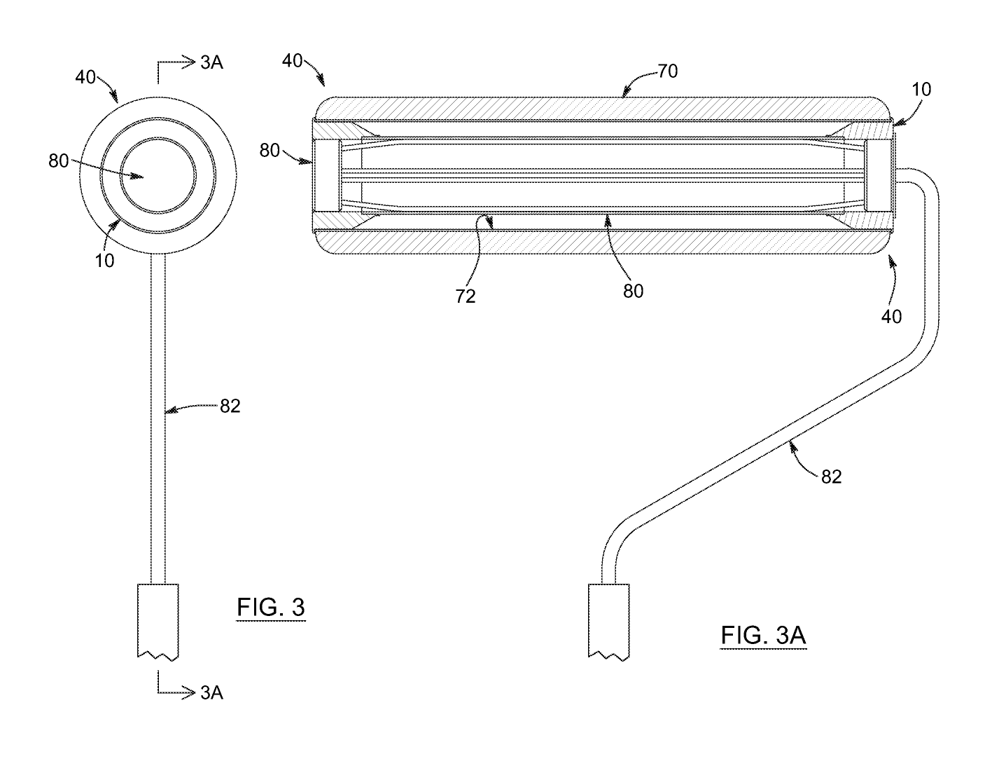

Generally speaking, and as shown in FIG. 3, the roller frame (80) has two distal ends. One of these ends can be connected to a handle (82) for holding and operating the roller frame (80). Before inserting the roller frame (80) into the roller cover (70), two roller cap assemblies (10) can be applied to the distal ends (40) of the roller cover (70). Then, the roller frame (80) is inserted through the opening at a distal end (40) of the roller cover (70) and is slid through the roller cover (70) until the frame (80) reaches the other distal end (40) of the roller cover (70).

As can be understood by referring to FIG. 1, the cap (10) receives and secures the distal ends of the roller frame (80). The cap (10) can have many different profiles or shapes, depending on the profile or shape of the distal end (40) of the roller cover (70) into which it is inserted. Preferably, the cap (10) has a profile selected from the group consisting of a circle, an ellipse, a quadrilateral, a triangle, a polygon, a star and/or any other shape or profile suitable for receiving the distal end (40).

Referring now to FIG. 4, the cap (10) is preferably a cylinder with two ends. The first end forms the mounting portion (20) and the second end forms the receiving portion (30). This cylinder can be of a variable or a fixed geometry. In the variable geometry configuration, the cylinder can be substantially conical-shaped because both ends conform to different diameter parameters (i.e. the mounting portion (20) corresponds to the diameter of the roller cover, and the mounting portion (30) corresponds to the diameter of the roller frame).

According to another preferred aspect of the present invention, the cap (10) consists of first and second connected cylinders (i.e. the receiving and mounting portions (30,20), respectively). The first cylinder (30) preferably has a smaller diameter than the second cylinder (20). Preferably, the diameter of the cylinders (30,20) can vary depending on the inner diameter of the roller cover, and either cylinder (30,20) can have a diameter in the range of about 1″ to 2″, although other diameters are also possible. The first cylinder (30) has a first end that is insertable inside the roller cover and provides the aperture (32) for frictionally engaging with the distal end of the roller frame (80). The second end of the first cylinder (30) provides an outward opening, such as the passage (34). The second cylinder (20) also has two ends. The first end is connectable to the first cylinder (30) at the passage (34) or adjacent thereto. This connection is preferably done by using a mechanical fastener, plastic moulding or welding during the manufacturing process, or by any other similar device and/or procedure known in the art. The second end is at the distal end (40) of the roller cover (70). As mentioned previously, the second end of the second cylinder (20) has a diameter that is substantially similar to the inner diameter of the roller cover (70) so as to frictionally engage with the roller cover (70). Both the first and second cylinders (30,20) cooperate so as to receive the roller frame (80) at the aperture (34) and to secure the roller cover (70) to the roller frame (80).

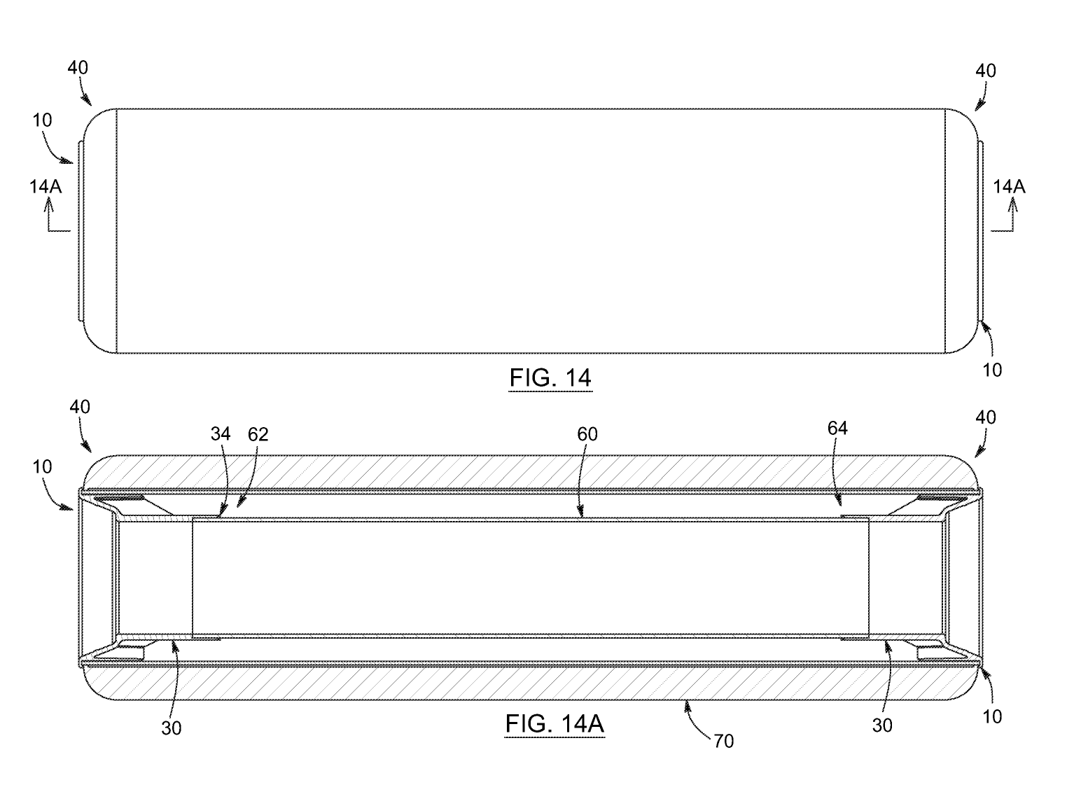

According to another preferred embodiment of the invention, and as illustrated in FIG. 14, the aperture (34) of the first cylinder (30) may be connected to an inner tube (60) which extends within the roller cover (70) and preferably connects to the cap (10) attached at the other distal end (40) of the roller cover (70). The connection of the roller caps (10) to the inner tube (60) is preferably secured by press fitting, interlocking, an adhesive and/or any other suitable techniques and/or procedures known in the art. The inner tube (60) is preferably a PVC tube, of appropriate diameter, although other suitable materials can be also used.

Preferably, and as illustrated in FIG. 5, the second cylinder (20) overlaps the first cylinder (30) near the passage (34) of the first cylinder (30) so as to ensure easy entry and passage of the roller frame (80) through the cap (10). In this preferred configuration, the first cylinder (30) and/or the second cylinder (20) can have variable or fixed diameters, as described above, provided that the diameter of the first cylinder (30) is such that it can frictionally engage with the distal end of the roller frame (80), as understood by a person skilled in the art. This preferred configuration is intended to facilitate entry of the roller frame (80) into the roller cap (10) and/or roller cover (70). Another preferred embodiment that can accomplish the same objective is to provide the second cylinder (20) with a variable diameter along its length, so as to give the second cylinder (20) a conical shape. At one end, the passage (34), the diameter of the second cylinder (20) is substantially similar to the diameter of the first cylinder (30) at the passage (34). The second cylinder (20) expands in diameter towards its other end, the fixture (24). In the overlapping configuration, various types of supports (50) such as, but not limited to, vanes, struts, bars, rods and/or any other similar support preferably connect the first and second cylinders (30,20) so as to provide structural rigidity to the cap (10). This configuration allows, for example, a compressive force to be applied to the second cylinder (20) so as to deform it, thus facilitating its insertion into the roller cover (70), all the while maintaining the structural integrity of the cap (10). Preferably also, both first and second cylinders (30,20) are somewhat deformable in response to an outside pressure so as to facilitate the cap's (10) entry into the roller cover (70). The cap (10) and/or first and second cylinders (30,20) preferably have interior surfaces which are at least partially coated so as to provide a gloss and/or mirror finish.

The distal end of the roller frame (80) can have different shapes, diameters and/or profiles. Consequently, the aperture (32) can have multiple different shapes or profiles such as, but not limited to, a circle, an ellipse, a quadrilateral, a triangle, a polygon, a star, and/or any other shape or profile or combination thereof that is suitable for receiving the roller frame (80). The first and/or second cylinders (30,20) can also have such profiles and/or shapes.

It is useful to talk about a preferred method of using the above-described roller cap (10), as better explained herein. When in use, a user applies the roller cap (10) as defined above to both distal ends (40) of the roller cover (70). The user then inserts the roller frame (80) at one of the distal ends (40), and guides the roller frame (80) through the second cylinder (20) and then the first cylinder (30) of the roller cap (10) installed at one of the distal ends (40). The user then guides the roller frame (80) through the first cylinder (30) and then the second cylinder (20) of the roller cap (10) installed at the other distal end (40), thus securing the roller cover (70) to the roller frame (80). The resulting device is a paint roller or tool that can be used to apply paint to surfaces, for example.

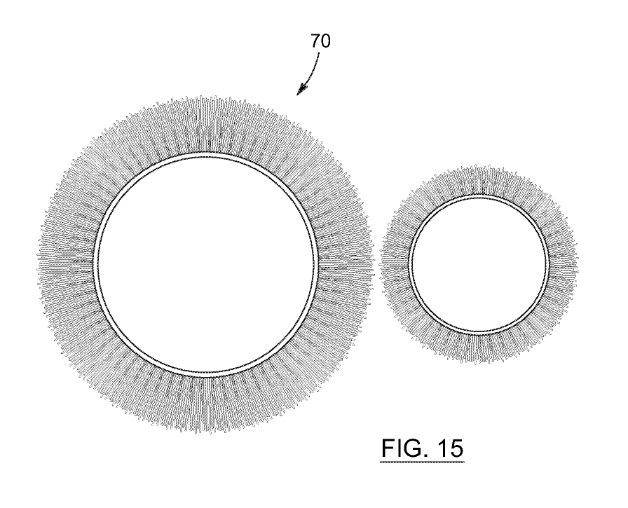

Indeed, this preferred method of using the roller cap (10) is even easier to comprehend when viewing the differences between an oversized roller cover (70) and a standard roller cover known in the art, as illustrated in FIG. 15. The oversized roller cover (70) preferably has a larger inner diameter than the standard roller cover, and is shown before being fitted with the roller cap (10). Preferably, the inner diameter of the oversized roller cover (70) is about 2″, which is larger than the inner diameter of roller covers known in the art, which is usually 1.5″.

As previously explained, the roller cover (70) is generally secured to the roller frame (80) by friction forces created by the roller cap (10), which prevents or limits movement of the roller cover (70) relative to the roller frame (80). One of these friction forces is created by the tight fit with which the roller cap (10) engages the roller frame (80) due to the similar diameters and/or shapes of the roller frame (80) and the aperture (32). Another of these friction forces is created by the frame (80) itself, which generally has frame elements which deform so as to facilitate the insertion of the frame (80) into the roller cover (70). Once inside the roller cover (70), these elements “bounce-back” and apply a radial force against the interior of the roller cover (70) and roller cap (10), thus reducing movement of the roller cover (70) relative to the frame (80). The combination of these two friction forces reduce relative movement of the roller cover (70) with regard to the frame (80), which helps to ensure that there is no slippage when the two rotate.

The roller cap (10) is preferably made from a polymer material which is impermeable and malleable, and capable of providing a smooth surface finish. Preferably, the roller cap (10) is made by extrusion moulding heated polymer tablets or granules. The grippers (60) are preferably made of a rubber or other similar substance suitable for gripping the interior of the roller cover (70), as apparent to a person skilled in the art.

Finally, and according to the present invention, the roller cap (10) and corresponding parts are preferably made of substantially rigid materials, such as hardened polymers, composite materials, and/or the like, depending on the particular applications for which the roller cap (10) is intended for and the different parameters in cause (i.e. load applied by the roller cover (70) and its rotation, diameter of roller cover (70) and/or frame (80), etc.), as apparent to a person skilled in the art.

Furthermore, the present invention is a substantial improvement over the prior art in that, by virtue of its design and components, the roller cap (10) provides an efficient and affordable technique for adapting a larger-diameter or super-sized roller cover so as to be used on a standard roller frame, which is cheaper than a super-sized roller frame. Furthermore, the roller cap (10) is impermeable to water or paint, easy to remove and clean, and it is also reusable for different roller covers and roller frames, thus reducing costs.

Since the roller cap (10) can be made from recycled polymers, it is relatively cheap to manufacture and is environmentally sustainable as well because it provides a use for polymer materials that may otherwise become landfill.

A further advantage resides in the fact that the weight of the tool created by combining a standard roller frame (80) with a large-diameter roller cover (70) by using the roller cap (10) is greatly reduced when compared to a super-sized roller cover in combination with a super-sized roller frame.

Moreover, the varying shapes of aperture (32) advantageously allow the roller cap (10) to adapt to many differently shaped distal ends of a roller frame (80).

The use of polymer materials further reduces costs because polymer of the granule or powder variety is easily extruded into multiple shapes and/or colors, as befitting the requirements of the inner opening (26).

Furthermore, oversized roller covers (70) also provide advantages over known conventional roller covers in that: a) they generally have bigger outside diameters; b) they can fit with all standard roller cages and trays in the market; c) they have superior paint pick and can hold about 30%-40% more paint; d) they can be made from microfiber fabric (i.e. Ultra Touch®); e) they can be made from recycled plastic; f) they can be lint free; g) they can cover more area with one dip; h) they can save time and improve productivity; i) they are relatively easy to clean; j) they can provide an exceptionally smooth finish; k) they are designed for large surfaces; etc.

Of course, numerous modifications could be made to the above-described embodiments without departing from the scope of the invention, as defined in the appended claims.

1. A cap for removably mounting onto a distal end of an oversized roller cover so as to enable the oversized roller cover to be used with a standard roller frame, the cap comprising:
a mounting portion removably mountable onto the distal end of the oversized roller cover, the mounting portion having a peripheral outer surface configured for frictional engagement with an inner bore of the oversized roller cover; and
a receiving portion operatively connectable to the mounting portion for removably receiving the standard roller frame, the receiving portion having an aperture configured for frictionally receiving the standard roller frame, thereby enabling the oversized roller cover to be used with the standard roller frame.

2. A cap according to claim 1, wherein the peripheral outer surface of the mounting portion is substantially cylindrical and defines an outer surface diameter.

3. A cap according to claim 2, wherein the aperture of the receiving portion is cylindrical and defines an aperture diameter, the aperture diameter being smaller than the outer surface diameter.

4. A cap according to claim 2, wherein the outer surface diameter is substantially equal to an inner bore diameter of the inner bore so as to enhance the frictional engagement of the mounting portion with the inner bore of the oversized roller cover.

5. A cap according to claim 2, wherein the outer surface diameter is about 2 inches.

6. A cap according to claim 3, wherein the aperture diameter is substantially equal to a frame diameter of the standard roller frame.

7. A cap according to claim 1, wherein the mounting portion comprises a fixture configured for being engaged with the oversized roller cover so as to prevent the mounting portion from moving inwardly into the oversized roller cover.

8. A cap according to claim 7, wherein the fixture comprises an extension disposed along at least part of the peripheral outer surface and operatively engaged with the distal end of the oversized roller cover.

9. A cap according to claim 8, wherein the extension is selected from the group of protrusions consisting of a brim, a rim, a lip, and a skirt.

10. A cap according to claim 1, wherein at least one support structure connects the receiving portion to the mounting portion so as to provide structural rigidity to the cap.

11. A cap according to claim 10, wherein the at least one support structure comprises a plurality of spaced-apart support structures, each support structure extending radially between the receiving portion and the mounting portion

12. A cap according to claim 11, wherein each spaced-apart support structure is an element selected from the group consisting of a vane, a strut, a bar, and a rod.

13. A cap according to claim 1, wherein the mounting portion comprises a peripheral inner surface being substantially frustoconical in shape.

14. A cap according to claim 13, wherein the peripheral inner surface defines an inner surface diameter varying along a length of the mounting portion.

15. A cap according to claim 14, wherein the inner surface diameter decreases along the length of the mounting portion in a direction away from the distal end of the oversized roller cover.

16. A cap according to claim 1, wherein the peripheral outer surface of the mounting portion comprises at least one friction enhancer for enhancing the frictional engagement of the peripheral outer surface with the inner bore of the oversized roller cover.

17. A cap according to claim 16, wherein the at least one friction enhancer is disposed along at least part of the peripheral outer surface.

18. A cap according to claim 16, wherein the at least one friction enhancer comprises a plurality of friction enhancers, each friction enhancer selected from the group of protuberances consisting of ribs, grips, nubs, strips, and bands.

19. A cap according to claim 1, wherein the aperture of the receiving portion creates a passage through the receiving portion and the mounting portion.

20. A cap according to claim 1, wherein the mounting portion is substantially deformable in response to a radial compressive force applied against the peripheral outer surface so as to facilitate mounting of the mounting portion onto the distal end of the oversized roller cover.

21. A cap according to claim 1 comprising an inner tube for frictionally receiving the standard roller frame, the inner tube being disposed within the oversized roller cover and removably mountable to the aperture of the receiving portion.

22. An inner tube in combination with two caps according to claim 1, the inner tube frictionally receiving the standard roller frame and being disposed within the oversized roller cover, the inner tube comprising opposed first and second extremities and configured such that the first extremity is removably mountable to the aperture of one cap and the second extremity is removably mountable to the aperture of the other cap.

23. A kit for assembling a resulting painting tool, the kit comprising:
an oversized roller cover;
a standard roller frame; and
art least one cap comprising:
a mounting portion having a peripheral outer surface configured for frictional engagement with the oversized roller cover; and
a receiving portion operatively connectable to the mounting portion, the receiving portion having an aperture for receiving the standard roller frame.

24. A cap for adapting onto a roller frame having a rotatable cage with an outer configuration intended to be used with a first type of roller cover having a given inner bore, so as to enable said roller frame via the cap to be used with a second type of roller cover having a larger inner bore, the cap comprising:
a mounting portion having an aperture configured for removably mounting about a portion of the cage of the roller frame; and
a receiving portion projecting radially outwardly from the mounting portion, and having an outer peripheral receiving surface complementary to the inner bore of the second type of roller cover for allowing the roller frame to receive said type of roller cover.
